(19) United States
(12) Patent Application Publication
(10) Pub. No.: US 2016/0338482 A1
(43) Pub. Date: Nov. 24, 2016

(54) COLLAPSIBLE WASHING TABLE FOR SUPPORTING SUCH AS A BARBECUE GRATE DURING CLEANING OF THE SAME AND INCLUDING PIVOTALLY ADJUSTABLE CLAMPING BRACKET AND SEPARATE CLEANING BRUSH WITH INTERNAL FLUID CONDUIT COMMUNICATING STRUCTURE FOR FACILITATING CLEANING OF THE SAME

(71) Applicant: Jerelle Hannah, Lathrup Village, MI (US)

(72) Inventor: Jerelle Hannah, Lathrup Village, MI (US)

(21) Appl. No.: 14/719,067

(22) Filed: May 21, 2015

(51) Int. Cl. A46B 11/06; B08B 3/10; B08B 1/00

(52) U.S. Cl. CPC A46B 11/066; B08B 1/002; B08B 3/10

(57) ABSTRACT

A collapsible table for supporting a grate. The table includes a perimeter frame and, in one embodiment, a plurality of elongate extending and pivotally adjustable legs. A clamp extends from the frame and engages an end location of a grate to be cleaned in repositionable fashion upon the frame. A fluid communicating cleaning brush is provided and includes a linear elongated and internally hollowed body including a first fluid coupling attachable end and a second fluid flow distributing end coinciding with placement of a plurality of bristle portions. An intermediate positioned valve is located within a fluid communicating interior of the body and actuating between a first position to permit fluid flow through to said bristle portions and a second position interrupting fluid flow. A female threaded interior defined at a rear end of the body is engaged by a male threaded exterior associated with a garden hose.

### FIELD OF THE INVENTION

The present invention discloses a collapsible table support for use with a barbecue grate or the like and which enables more effective cleaning of the grate. A separate grill cleaning brush is provided with internal conduit for delivering a pressurized fluid through a scrub head to assist in cleaning of the grate and which can be combined into an assembly with the collapsible table.

### BACKGROUND OF THE INVENTION

Collapsible table structures are known in the relevant art, such as for varied outdoor applications. Examples of these include the folding worktable for an outdoor grill set forth in Ducate, Jr., U.S. Pat. No. 8,607,777 and U.S. Pat. No. 8,522,769. Also referenced is the combination collapsible barbecue grill and folding table of Rivera, U.S. Pat. No. 6,302,097 and the collapsible grill supporting table of Williams, U.S. Pat. No. 5,964,160.

Also known are examples of grill related cleaning brush accessories, such as which can be utilized for cleaning a grill top grate or the like. Examples of these include the grill brushes of MacDonald, U.S. Pat. No. 6,443,646 and Wales, US 2009/0056748, both of which combine steel bristle like scraper elements with an internal fluid communicated reservoir.

### SUMMARY OF THE PRESENT INVENTION

The present invention recites both a collapsible table for supporting a grill grate during cleaning, as well as a separate fluid communicating and cleaning brush. The grate support table and cleaning brush can be provided both separately and in assembly or kit combination. The present invention also contemplates either component being utilized with other and additional components not limited to those described herein.

The collapsible table supporting the grate like structure according to a first embodiment includes a central and vertically extending column, with a plurality of perimeter spaced outer columns interconnected to the central column by articulating frame portions. An upper extending location associated with at least the outer columns defines a support for restraining and seating a location associated with the grate. At least one actuating portion is mounted to the central column and includes additional displacing stems engaging intermediate locations associated with each of the articulating frame portions in order to convert the table between an outwardly extended support position and an inwardly retracted non-use position.

Other features include the provision of upper and lower tiers of articulating frame portions, with upper and lower tiers of vertically displaceable collars mounted to each of the central column and the perimeter spaced columns and between which are mounted the articulating frame portions. The actuating portions can also include upper and lower vertically displaceable drum portions supporting the hingedly extending stems connecting to articulating locations associated with each of the upper and lower tier frame portions, the drums being actuated by a release trigger to slide in oppositely and linearly outwardly movable fashion along the central column to outwardly collapse the articulating frame portions.

Other features include a selected upper end location of an outer column further exhibiting a gripping structure including first and second clamping members for biasingly engaging a corner location of the grate. The grate gripping structure is further exhibited by a hinged connection to the associated column for permitting the clamping members to pivot the grate from a first horizontally supported position to a further upwardly angled position.

The upper extending support locations further exhibit top mounted crown portions with interior seating locations for supporting and restraining corner locations of the grate. Also included are cushioned pedestal supports mounted to bottom ends of the central and outer perimeter columns.

In a second embodiment, the collapsible table with grate support includes a four sided frame. A first pair of parallel and spaced apart sides interconnects a second pair of telescopically adjustable sides. A fixture extending from a selected one of the first pair of spaced apart sides incorporates a similar grate gripping structure, further including a hinged connection supporting a pair of clamping members for supporting and pivot the grate between horizontally and upwardly angled positions. In combination with the telescoping adjustment of the second pair of sides for accommodating varying grate sizes, the other selected of the first pair of sides of the frame includes a grate support clip for engaging a side location of the grate opposite a further side secured between the clamping members.

A plurality of legs extend from corner locations of the four sided frame. The legs are spring biased into engagement with the corner locations and, upon being counter bias separated, can be rotated from use to storage positions in which they extend parallel to the frame sides.

A fluid communicating cleaning brush is also provided and includes a linear elongated and internally hollowed body including a first fluid coupling attachable end and a second fluid flow distributing end coinciding with placement of a plurality of bristle portions. An intermediate positioned valve is located within a fluid communicating interior of the body and actuating between a first position to permit fluid flow through to said bristle portions and a second position interrupting fluid flow. Additional features of the fluid coupling further include a female threaded interior defined at a rear end of the body which is engaged by a male threaded exterior associated with a garden hose.

The valve may also include a ball valve seated within an interior seat defined within the body and which is actuated by a rotating knob supported atop the body which engages an upwardly extending post associated with the valve. The second flow distributing end further includes a plurality of apertures defined within a flattened end profile in cooperation with mounting of the bristle portions.

Other features associated with the brush body include it exhibiting a relatively flattened top and a three dimensional interior, the top and body exhibiting mating and seating profiles and each further exhibiting a plasticized construction which is assembled in a vibration or sonic welding operation. Other features include a soap dispenser sub-assembly located forwardly of the fluid flow valve and which is rotated between a first closed and rinse position and a second open and soap dispensing position.

An arcuate seat is formed in a fluid communicating location of the elongated body for seating either of a cylindrical or pseudo-cylindrical shaped dispensing body. An annular seat defined in the flattened top communicates a twist cap with the sealed soap dispenser between the rinse and soap dispensing positions.

Additional features include an O-ring seat positioned between the twist cap and the annular seat. A tab and slot configuration is established between the cap and annular seat for facilitating rotation of the soap dispensing body between rinse, soap dispensing and subassembly removal positions.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the collapsible grate cleaning table in an extended and supporting position;

FIG. 2 is a side view of the table shown in FIG. 1;

FIG. 3 is a top view of the table;

FIG. 4 is a sectional cutaway taken along line 4-4 of FIG. 3 and showing the clamping support for securing portion of a grate;

FIG. 5 is a ninety degree rotated cutaway view taken along line 5-5 of FIG. 3 of the clamping support and further depicting the tightening bolt for permitting angular repositioning of the clamp;

FIG. 6 is a cutaway view taken along line 6-6 of FIG. 3 and depicting a first depiction of the vertically displaceable intermediate drum supports associated with the central vertical column and in turn supporting hingedly connected upper and lower pivotal pluralities of selectively extendible and collapsible frame members;

FIG. 7 is a cutaway view taken along line 7-7 of FIG. 3 and showing a further angular depiction of the central support column with upper hingedly collapsible and vertically displaceable collar;

FIG. 8 is a cutaway taken along line 8-8 of FIG. 3 and depicting an end support location of a perimeter supported and vertically displaceable coupling;

FIG. 9 is a cutaway taken along line 9-9 of FIG. 3 and depicting a further vertically displaceable location associated with either of an upper or lower vertically displaceable central coupling which in turn supports a plurality of outwardly extending frame portions in turn engaging each of a plurality (4) perimeter located displaceable couplings such as depicted in FIG. 8;

FIG. 10 is a cutaway view taken along line 10-10 of FIG. 3 and illustrating a perimeter located support with vertically displaceable coupling at a different cross sectional location;

FIG. 11 is a cutaway view taken along line 11-11 of FIG. 2 and illustrating a central cross sectional cutaway of a selected perimeter column supported and vertically displaceable upper coupling;

FIG. 12 is a further cutaway view taken along line 12-12 of FIG. 2 and showing a further selected lower perimeter column supported and vertically displaceable coupling at a different cross sectional location which additionally illustrates the outwardly extending collapsible lower frame portions;

FIG. 13 is a vertical cutaway taken along line 13-13 of FIG. 2 and showing a geometry of an associated perimeter located vertical column;

FIG. 14 is a collapsible illustration of the table depicted from a first angle;

FIG. 15 is a further illustration of the collapsed table from a ninety-degree rotated angle;

FIG. 16 is a top view of the collapsed table depicted in FIG. 14;

FIG. 17 is a first vertical cutaway depiction of the collapsed table taken along line 17-17 of FIG. 16;

FIG. 18 is a second vertical cutaway depiction of the collapsed table taken along line 18-18 of FIG. 16;

FIG. 19 is an illustration similar to FIG. 1 and illustrating the table in extended fashion with a grate supported thereupon in a first vertically disposed position with the clamp gripping a first corner and additional grate corners being supported upon top disposed seating notches defined in crown supports integrated into additional perimeter columns;

FIG. 20 is a succeeding view of the grate supported in FIG. 19 being pivoted upwardly relative to the clamping bracket to a vertically supported position;

FIG. 21 is a perspective view of a cleaning brush attachment with cleaning bristles and on/off fluid communicating valve;

FIG. 22 is a rotated and angled perspective depicting the brush attachment from a different angle and better depicting the threaded rear female or receiving coupling within which is threadably engaged a corresponding male attachment associated with such as a garden hose;

FIG. 23 is a top view of the brush attachment;

FIG. 24 is side view of the brush attachment;

FIG. 25 is a bottom view of the brush attachment;

FIG. 26 is a front view of the brush attachment;

FIG. 27 is a rear view of the brush attachment;

FIG. 28 is a linear cutaway view taken along line 28-28 of FIG. 23 and illustrating the fluid communicating interior of the brush attachment including rear threaded receiving coupling, intermediate rotary on/off valve and forward end located and spaced apart fluid discharge apertures interposed with downwardly arrayed cleaning bristles;

FIG. 29 is an enlarged sectional cutaway of the rotary on/off valve depicted by area 28-28 in FIG. 28;

FIG. 30 is a vertical cutaway taken along line 30-30 of FIG. 24 and illustrating the rotary valve from a ninety degree offset relative to that shown in FIGS. 28-29;

FIG. 31 is an exploded view of the brush attachment of FIG. 21;

FIG. 32 is a perspective view of a cleaning brush attachment according to a further variant compared to that depicted in FIG. 21 and which includes a soap dispensing feature incorporated into the handle forwardly of the on-off valve;

FIG. 33 is a top view of the alternate brush attachment of FIG. 32;

FIG. 34 is a succeeding side view of the brush attachment of FIG. 32;

FIG. 35 is a lengthwise side cutaway taken along line 35-35 of FIG. 33 and illustrating the fluid communicating interior of the brush attachment including rear threaded receiving coupling, intermediate rotary on/off valve, forward located soap dispensing feature with removable container, and forward-most end located and spaced apart fluid discharge apertures interposed with downwardly arrayed cleaning bristles;

FIG. 36A is a bottom cutaway view taken along line 36-36 of FIG. 34 and illustrating the interior lengthwise and fluid communicating passageway associated with the brush including the rotary valve in the open position, combined with the configuration of the forward positioned and fluidly communicating soap dispensing feature in a closed and rinse position;

FIG. 36B is a succeeding view illustrating the rotary valve rotated to a closed and flow interrupting position;

FIG. 36C is a further succeeding view in which the soap dispensing assembly is rotated to soap dispensing position in which resumption of fluid flow caused by re-opening of the rotary valve results in dispensing of a soap solution concurrent with cleaning action of the brush;

FIG. 37 is a cutaway view taken along line 37-37 of FIG. 33 and illustrating the inner communicating configuration of the forward located bristle component;

FIG. 38 is a rotated cutaway view of the forward bristle component illustrated in FIG. 37 and taken along line 38-38 of FIG. 33;

FIG. 39 is a cutaway view taken along line 39-39 of FIG. 33 and better illustrating the configuration of the soap dispensing feature;

FIG. 40A is a cutaway taken along line 40-40 of FIG. 39 and better illustrating the rotary seating profile established between the dispensing container and the surrounding configured seat established within the handle in a closed position;

FIG. 40B is a succeeding view in which the push and rotate feature associated with the cap portion rotated the container to an open and removal position;

FIG. 40C is a further succeeding view illustrating the stop feature associated with a raised portion of the tab rotation slot and in order to prevent over-rotation of the from either the rinse or soap positions;

FIG. 41 is an exploded view of the brush attachment depicted in FIG. 32;

FIG. 42 is a partially exploded view of the collapsible grate cleaning table according to a further embodiment;

FIG. 43 is a top plan view of the table shown in FIG. 42, with the grate removed and illustrating the four sided frame and illustrating a first pair of parallel and spaced apart sides interconnects a second pair of telescopically adjustable sides;

FIG. 44 is a side plan view of the table and illustrating a fixture extending from a selected one of the first pair of spaced apart sides incorporating a grate gripping structure further including a hinged connection supporting a pair of clamping members for supporting and pivot the grate between a horizontally supported use position to a further upwardly angled position;

FIG. 45 is a right side end view of the table of FIGS. 42-44;

FIG. 46A is a cutaway taken along line 46-46 of FIG. 44 and illustrating a selected telescoping side sub-assembly in an extended position;

FIG. 46B is a succeeding view to FIG. 46A and illustrating the telescoping side sub-assembly in a collapsed position;

FIG. 47 is a cutaway view taken along line 47-47 of FIG. 44 and illustrating an interconnecting corner of the table including a spring loaded and rotatable leg;

FIG. 48A is a cutaway view taken along line 48-48 of FIG. 44 and illustrating a selected leg in a telescoping position;

FIG. 48B is a succeeding view to FIG. 48A and illustrating the leg in a telescopically collapsed position;

FIG. 49 is an exploded view of the grate support table of FIG. 42;

FIG. 50 is an exploded view of a selected rotatably supported and telescoping leg;

FIG. 51 is a perspective view of the grate support table in a collapsed and stored position;

FIG. 52 is a side view of the table shown in FIG. 51;

FIG. 53 is a corner exploded view of the leg to frame connection also depicted in cutaway in FIG. 47;

FIG. 54 is a cutaway taken along line 54-54 of FIG. 43 and further illustrating the grate table clamp and supporting fixture; and

FIG. 55 is a cutaway view taken along line 55-55 of FIG. 43 and illustrating a pivot support fastener associated with the grate clamp support fixture.

### DETAILED DESCRIPTION OF THE PREFERRED EMBODIMENTS

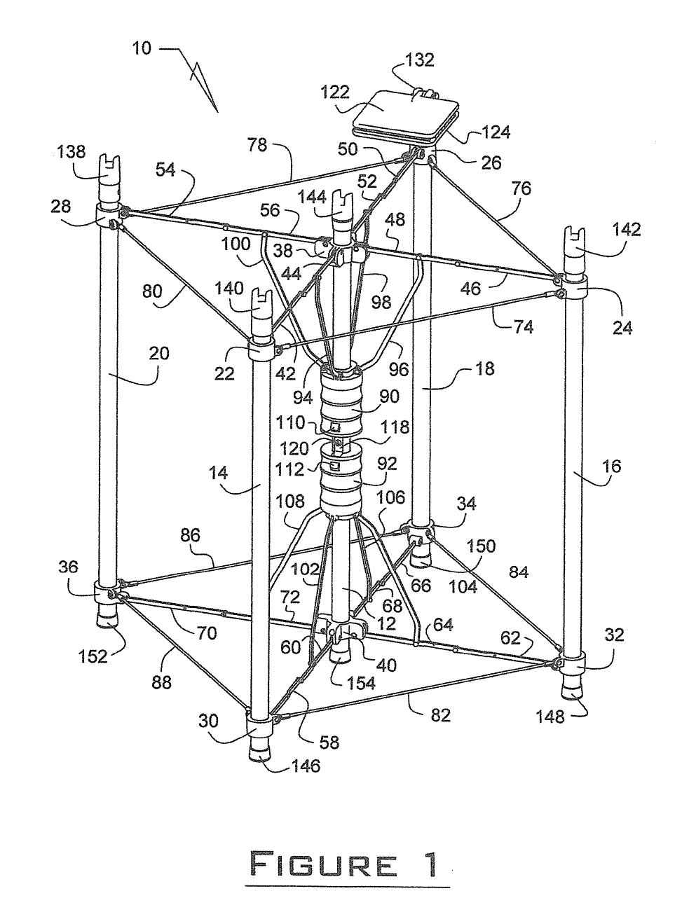

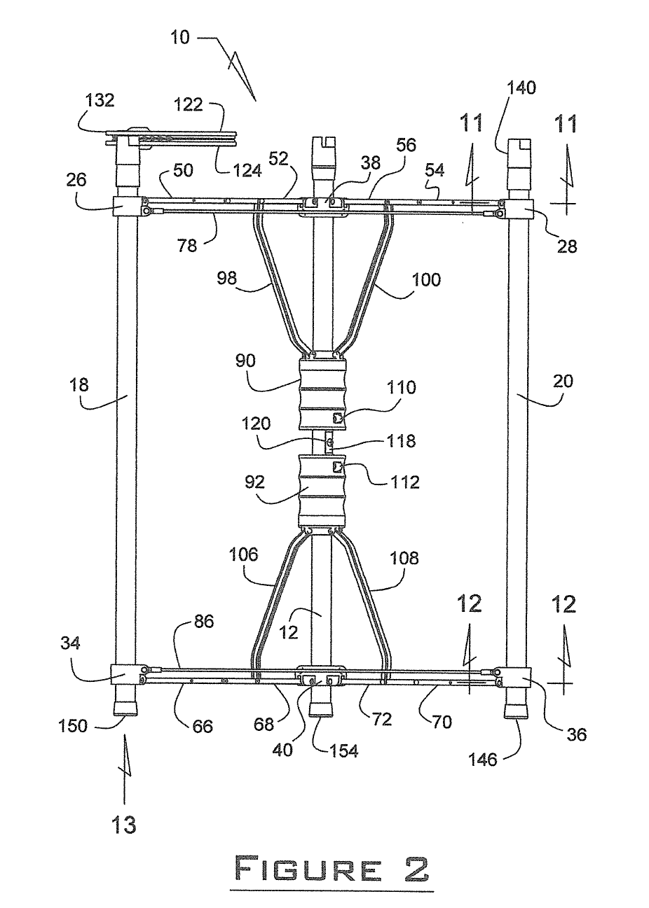

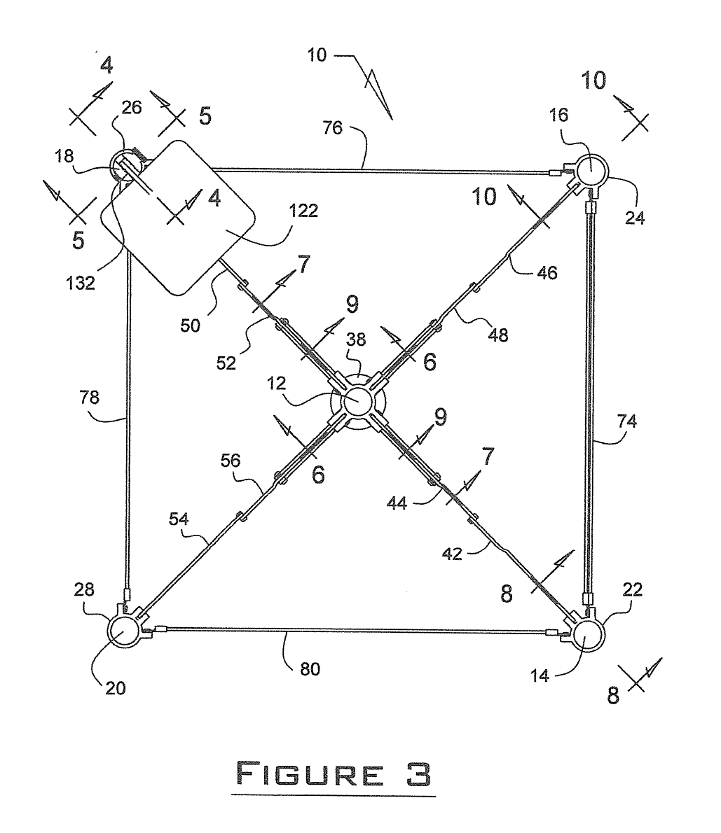

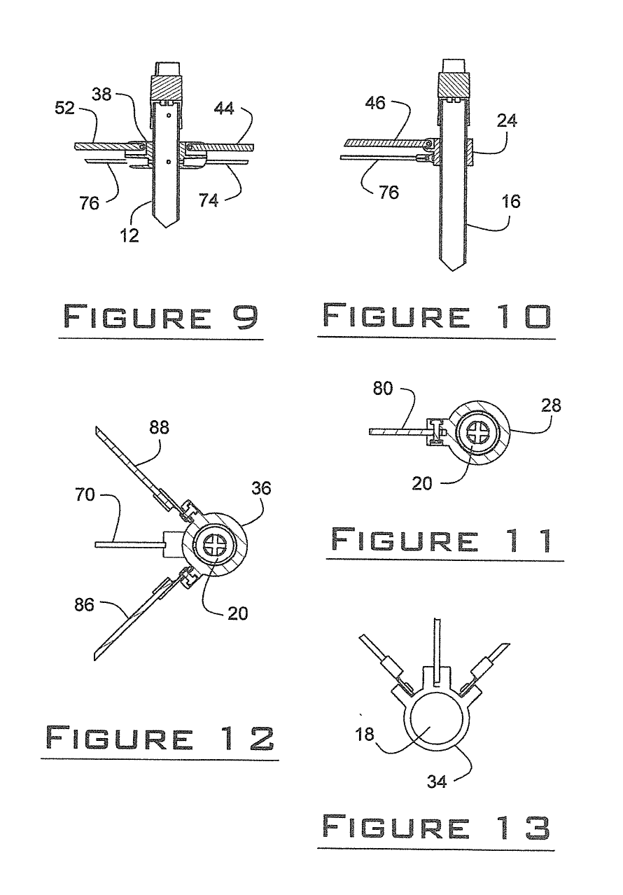

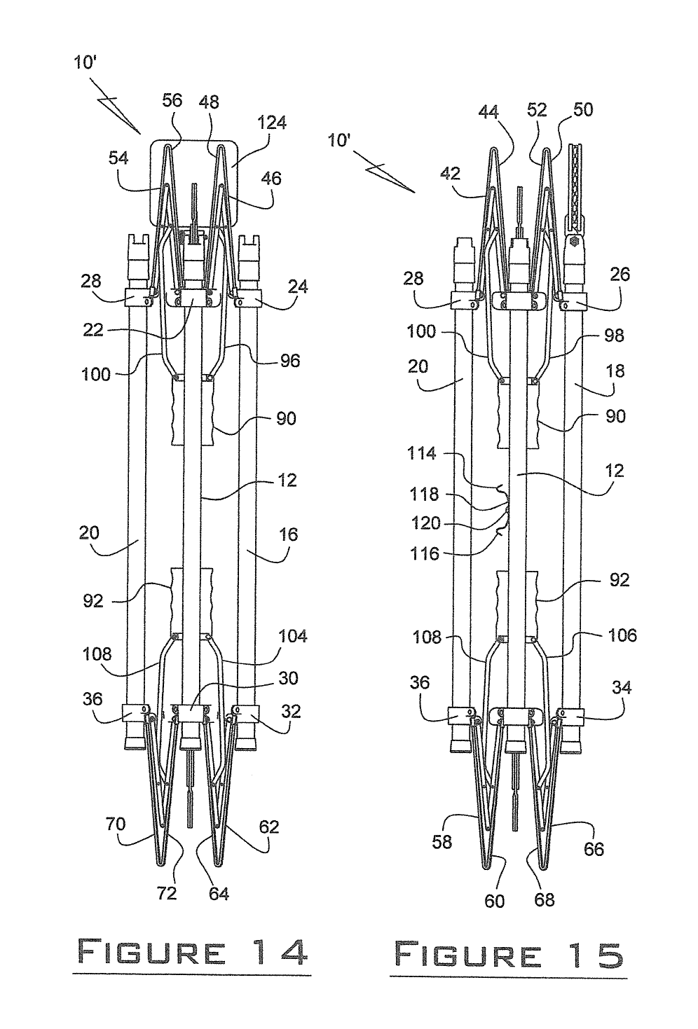

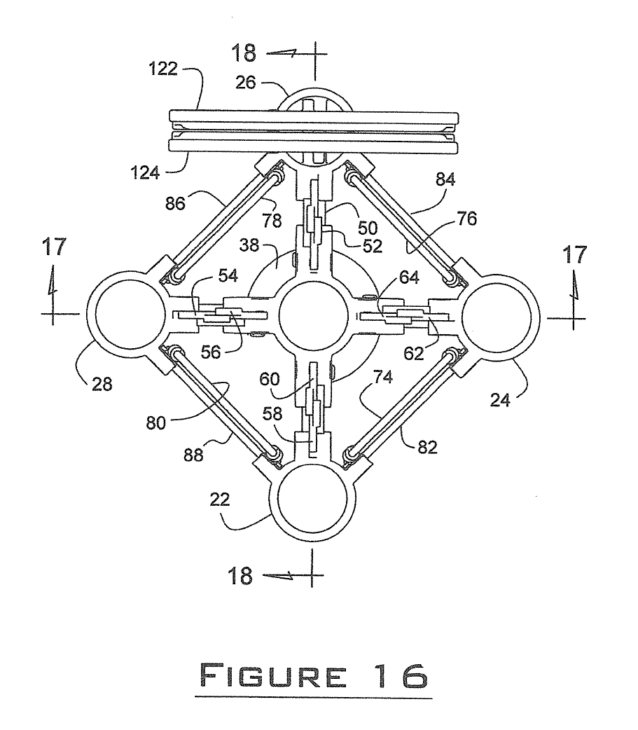

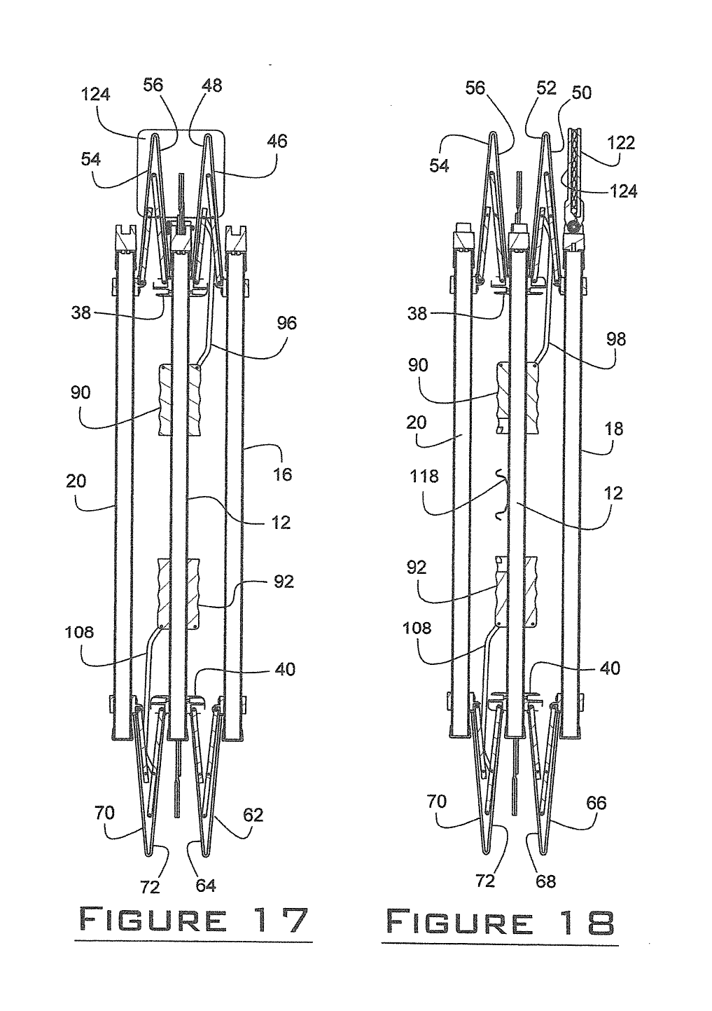

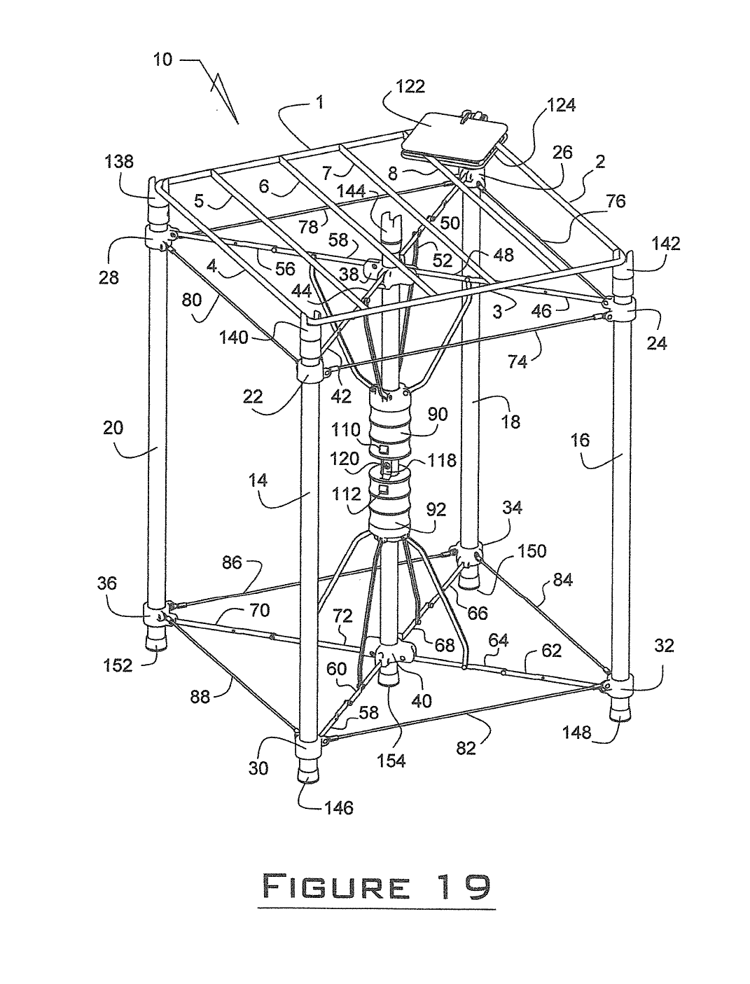

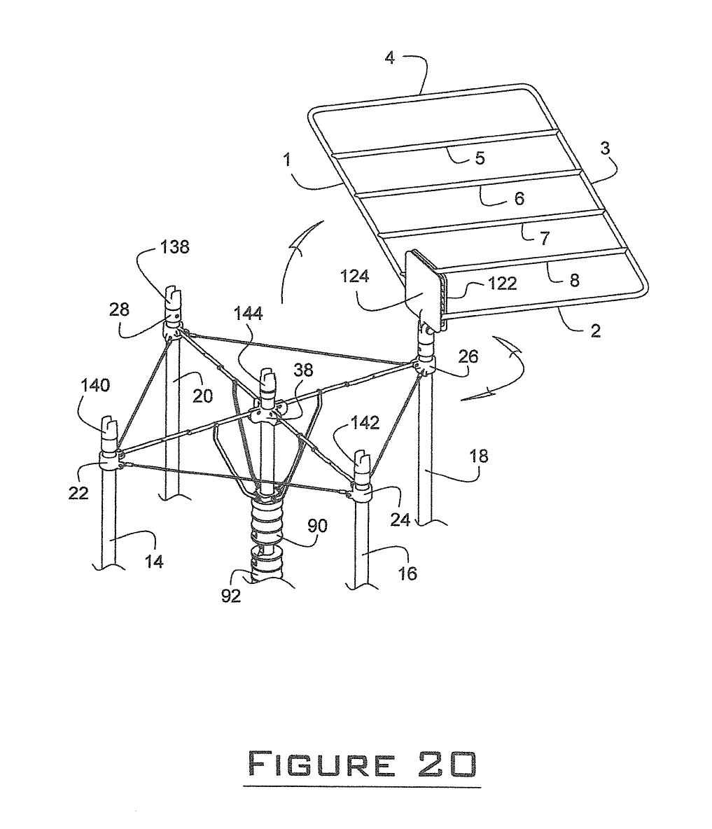

With reference now to the first set of illustrations depicted in FIGS. 1-20, a collapsible stand or table is depicted, see generally at 10 in each of FIGS. 1-3 and 19 in extended position and further at 10′ in further collapsed/retracted and rotated side views of FIGS. 14-15. As previously described, the table 10 is constructed for supporting a generally grid shaped grate (depicted in non-limiting fashion by selected rectangular depiction in FIGS. 19 and 20 and including four outer interconnecting sides 1, 2, 3 and 4, with additional spaced inner supports 5, 6, 7 and 8 extending between selected sides 1 and 3 and parallel to further outer sides 2 and 4. Beyond the grate design depicted in FIGS. 19 and 20, it is envisioned and understood that other polygonal shaped, circular or irregular pattern grates or supports are equally applicable for use with the collapsible table.

Referring again to FIGS. 1-3, the table includes a central and vertically extending column 12 and a further plurality (e.g. four in the illustrated variant) of outer spaced and perimeter defining columns 14, 16, 18 and 20. The main/central 12 and outer 14, 16, 18 and 20 columns can be constructed of any durable and suitable material such as not limited to a lightweight metal (aluminum) or durable polymer material (e.g. nylon, PVC, etc.).

The table further includes identical upper and lower collapsing subassemblies for selectively expanding and retracting the outer perimeter columnar supports 14, 16, 18 and 20 relative to the central main support 12, and to thereby convert between the extended and supported position of FIG. 1 and the retracted/collapsed position of FIGS. 14-15. Each subassembly includes a plurality of four vertically displaceable collars or couplings (see upper couplings 22, 24, 26 and 28 as well as lower couplings 30, 32, 34 and 36) located in upper and lower tiers associated with the perimeter spaced columns 14, 16, 18 and 20.

Additional vertically displaceable collars 38 and 40 are supported at equivalent height locations associated with the central/main support 12 and, in cooperation with each of the upper (22, 24, 26 and 28) and lower (30, 32, 34 and 36) perimeter displaceable couplings, establish collapsible frames. These include pluralities of upper and lower hingedly connecting frame or wire elements (see upper articulating pairs of frame elements 42 & 44, 46 & 48, 50 & 52 and 54 & 56 extending between upper tier perimeter couplings 22, 24, 26 and 28 and central upper coupling 38, as well as lower articulating pairs of frame elements 58 & 60, 62 & 64, 66 & 68 and 70 & 72 extending between lower tier perimeter couplings 30, 32, 34 and 36 and central lower coupling 40.

In cooperation with the upper and lower sets of articulating frame elements, additional and outer interconnecting and bendable lanyards or cables (such as without limitation including wire strand construction with outer polymer coating) are depicted by upper plurality 74, 76, 78 and 80 and lower plurality 82, 84, 86 and 88 extending between the upper (22, 24, 26 and 28) and lower (30, 32, 34 and 36) pluralities of displaceable collars in order to provide stability to the table when converted to the extended/use position of FIG. 1.

A pair of vertically displaceable intermediate drum supports are depicted at 90 and 92 and are associated with the central vertical column 12 such that they exhibit open circular interiors to facilitate vertical displacement along the central support 12 along with each of the upper and lower sets of displaceable collars or couplings. Upper 94, 96, 96 & 100 and lower 102, 104, 106 & 108 pluralities of opposite hinged connecting angular stems are provided and which extend respectively from the upper 90 and lower 92 drum supports to each inner articulating frame member (upper 44, 48, 52 and 56 and lower 60, 64, 68 and 72) in order to facilitate hinged collapsing of the upper and lower frame subassemblies between FIG. 1 and FIG. 14.

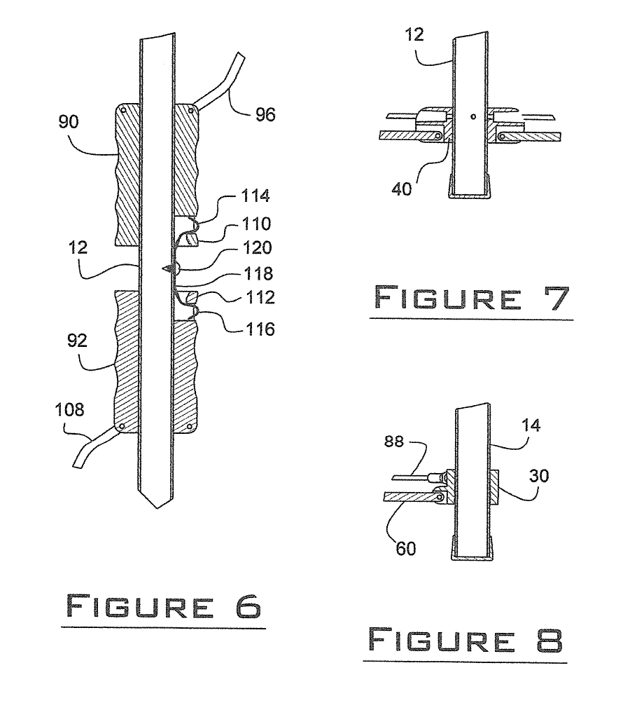

Depress triggers 110 and 112 are formed into the communicating interior architecture of the upper 90 and lower 92 drum supports such that in a first centrally displaced and engaging position (see cutaway of FIG. 6), the triggers 110 and 112 engage angled tang ends 114 and 116 of a spring clip 118 mounted (see screw 120) to a substantial vertical midpoint location of the central main column 12. Upon depressing the triggers 110 and 112, the drum supports 90 and 92 collapse outwardly in upper and lower opposite directions such that the upper and lower sets of pivoting stems 94-100 and 102-108 collapse the corresponding articulating frame members (upper 42/44, 46/48, 50/52 and 54/56 and lower 58/60, 62/64, 66/68, and 70/72) in order to achieve the inwardly drawn and linearly collapsed and non-use position of FIGS. 14-15.

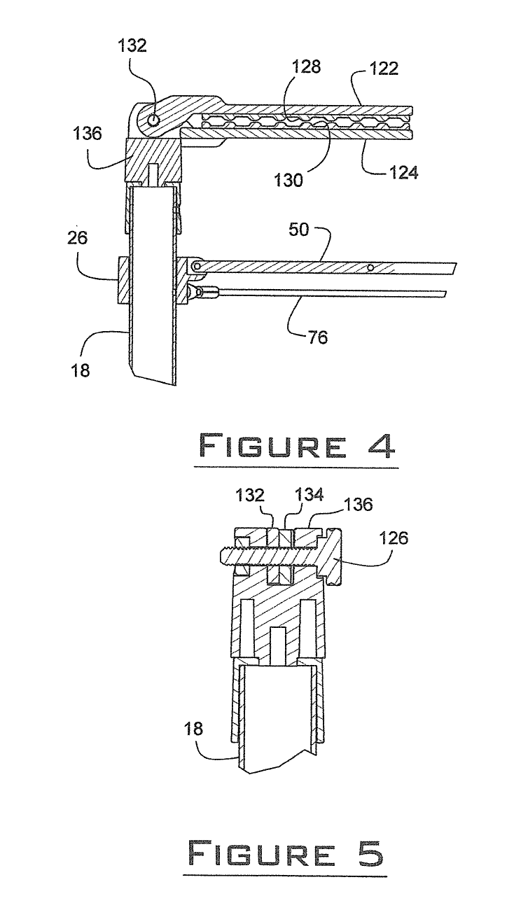

A clamping support is depicted by planar extending and gripping portions 122 and 124 and, as best shown in the successive cutaway views of FIGS. 4 and 5, include the upper planar portion 122 being pivotal relative to the lower portion 124, via a selectively loosenable and tightenable bolt 126 (FIG. 5) in order to selectively grip an edge location of the grate (again FIGS. 19 and 20). Undulating ridges or other uneven serrations or protuberances are exhibited along inner opposing faces of the gripping portions 122 and 124 (see at 128 and 130 in FIG. 4).

A hinged location 132 extending from a base of the upper gripping portion 122 facilitates opening and closing the upper portion 122 in order to grasp the grate edge location in biasing fashion against the lower gripping portion 124. As further shown in FIG. 5, the bolt 126 extends through aligning ears 132 and 134 corresponding to the upper 122 and lower 124 gripping portions, these in turn seating within a central recess defined within a selected crown 136 mounted atop the associated perimeter column 18, the bolt 126 being loosed in a first position to allow the upper gripping portion 122 and pivot and grasp the grate relative to the lower gripping portion 124 and, separately, to permit the gripping portions 122/124 to pivot between the grate horizontal supporting position of FIG. 19 and the vertically rotated and upwardly supported position of FIG. 20.

Additional features include a further plurality of three crown supports 138, 140 and 142 mounted atop associated perimeter columns 20, 14 and 16, along with a fourth additional and central crown support 144 mounted atop the central column 12, these in combination with the grate clamping assembly mounted atop further perimeter column 18 providing for seating of outer corner and/or inner grid locations of the grate. As shown, each of the additional crown supports exhibits upper facing seating notches for supporting (see FIG. 19) aligning corner locations of the grate when supported in the horizontal disposed position and to facilitate scrubbing/cleaning of the grate in minimally obscuring fashion.

Also depicted at cushioning foot or pedestal supports 146, 148, 150, 152 and 154 associated with bottom attachable locations of the four perimeter (14, 16, 18 and 20) and central 12 column supports. Beyond the configuration of table depicted in FIGS. 1-20, it is understood that additional contemplated variants could include differing configurations including, in one non-limiting instance, a lesser plurality of three outer perimeter extending columns arranged in a generally triangular shaped profile about a central main column. Additional greater pluralities of perimeter extending columns can also be arranged in further polygonal defining shapes about the central column support in association with similar frame collapsing structure as that described herein.

Yet additional variants can also envision the vertically displaceable upper and lower sets of collars or couplings being substituted by fixed locations on the inner/main and outer/perimeter supports, such that the articulating nature of the frame portions may be further modified to account for a static hinged connection to each column and in order to limit axial extension when retracted to the collapsed position of FIG. 14. The clamping supports shown at 122 and 124 may also be removed or substituted in further variants in favor of an additional notched crown element, and such as to mount and support a grate in a horizontal and easily reversible configuration such as depicted in FIG. 19.

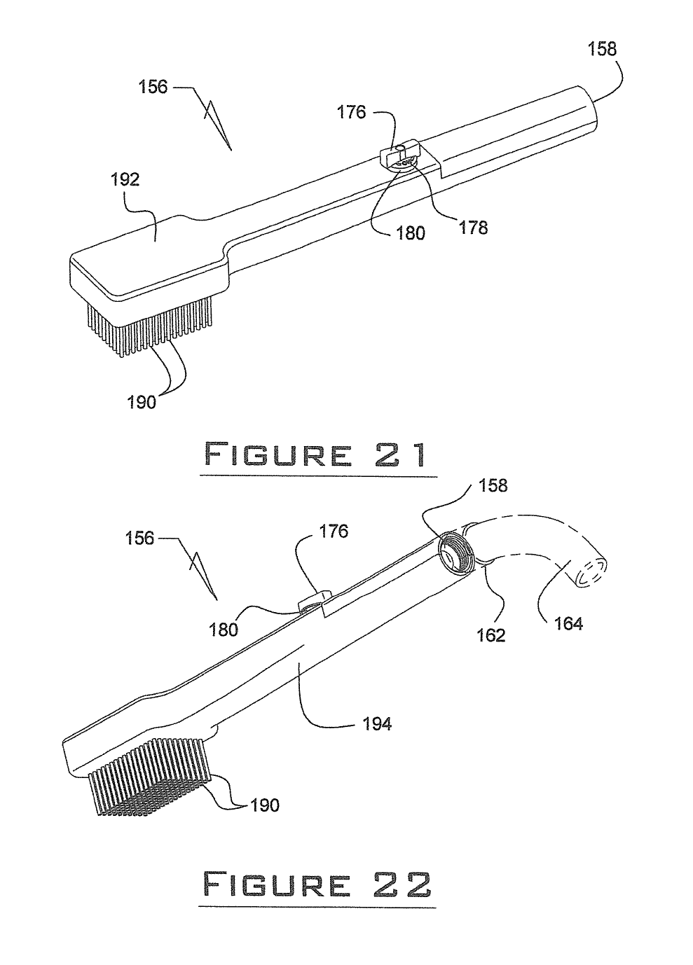

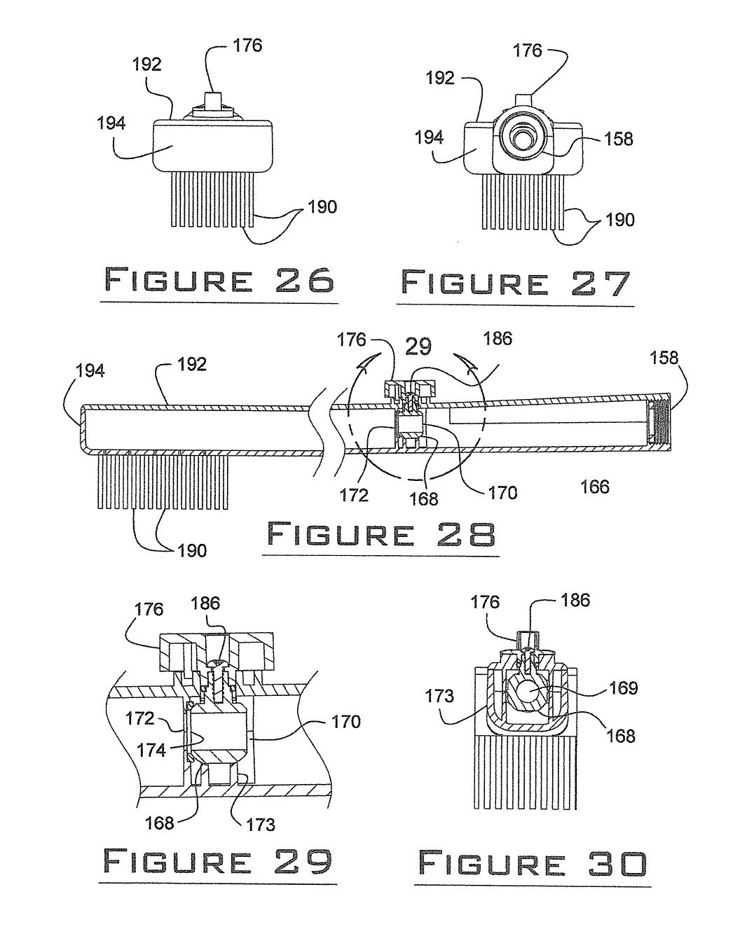

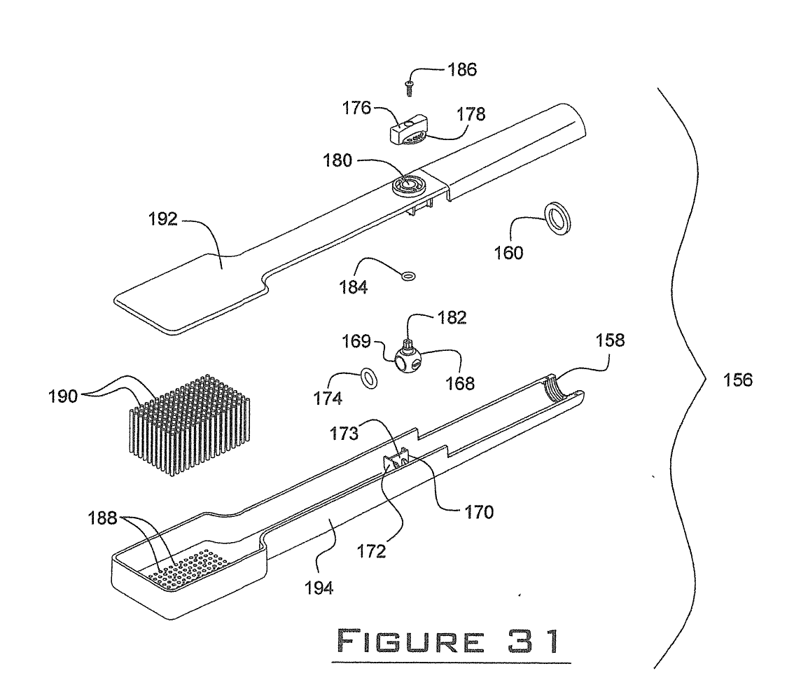

Referring collectively to FIGS. 21-31, a series of perspective, cutaway and exploded views are shown generally at 156 of a cleaning brush attachment which can be used in combination with the grate supporting stand, and such as in particular to enhance the cleaning of the grate. The attachment 156 exhibits a generally linear elongated configuration with a threaded rear female or receiving coupling 158 (see FIG. 22) with water seal promoting washer 160 (see further FIG. 31).

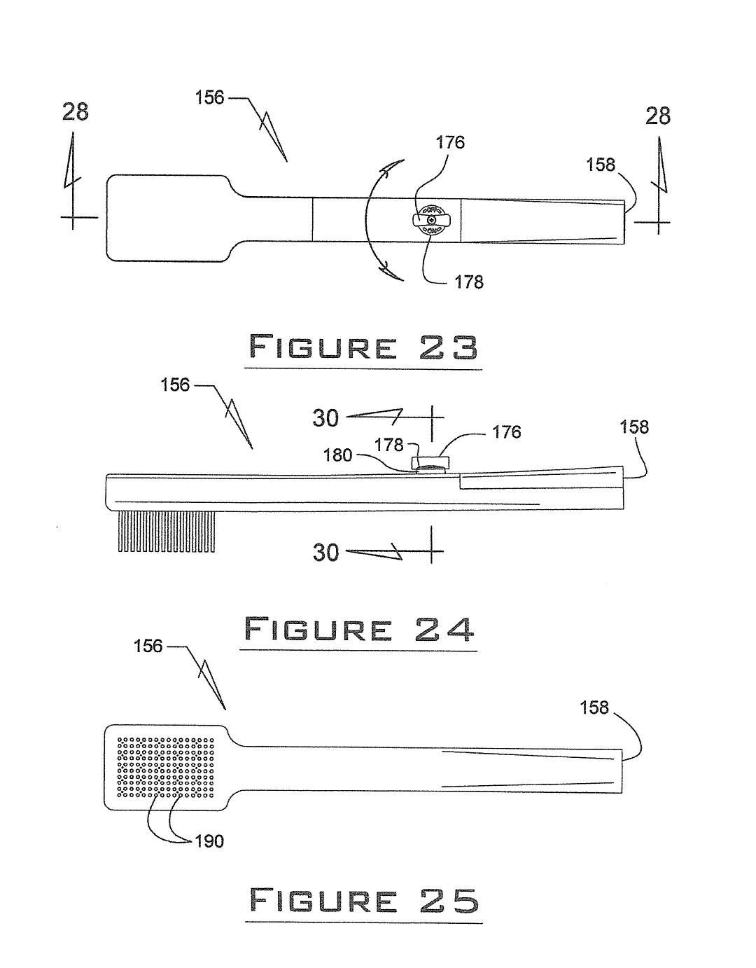

The female/receiver coupling 158 is engaged by a corresponding male externally threaded attachment 162 such as associated with a garden hose 164. As best shown in FIG. 28, a linear cutaway view taken along line 28-28 of FIG. 23 illustrates a fluid communicating interior 166 of the brush attachment extending from the rear internally threaded and female receiving coupling 158 to an intermediate located and rotary operable on/off valve (e.g. and which is depicted without limitation as a version a ball type valve) including a rotating element 168 better depicted in exploded fashion in FIG. 31 and illustrating a central aperture 169.

In this fashion, the element 168 is which is seated within an intermediate and rotatably supporting/selectively flow permitting location depicted by inlet side 170 and outlet side 172 which define a recessed seat (see at 173 in FIG. 31) established within the elongated fluid communicating interior of the attachment and which is dimensioned to support the rotating element 168. A further seal such as rubber washer 174 is provided at the outlet side 172.

As again best shown in FIG. 31, an exterior top located turn knob 176 is mounted atop the brush attachment and includes a circular underside template 178 with engages with a mating circular and rotatable portion 180 supported upon the top surface of the brush attachment. An upper extending post 182 associated with the rotating ball valve 168 receives a further specially sized rubber washer 184 and, when mounted within the brush attachment, projects through a central aperture associated with the surface supported portion 180. A threaded interior is exhibited within the exposed top of the post 182 and is engaged by screw 186 in order to rotatably slave the ball valve 168 with the top surface supported turn knob 176.

Upon rotating the knob 178 to turn the ball valve 168 to the open/flow communicating position (see FIG. 30), fluid is permitted to flow through the ball seat outlet 172 and through a forward linear extending location of the brush attachment until communicating with a flattened or planar surfaced forward end which is configured with a relatively large plurality of spaced apart fluid discharge apertures 188 which are interposed with downwardly arrayed cleaning bristles 190. As shown, the bristles 190 can be mounted in extending fashion through the forward end fluid discharge apertures 188, such that fluid travels at high discharge flow through a hollow interior defined in each bristle. Alternately or additionally, the bristles 190 can be mounted within specified apertures and with additional and alternating or interposed apertures remaining open to communicate fluid flow at a relatively high discharge rate (depending upon achieved inlet pressure) across the bristle zone.

The exploded view of FIG. 31 again depicts one non-limiting arrangement for constructing the brush cleaning attachment and which includes a generally two part body including an upper subassembly 192 (including generally upper flattened cover portion) and a lower base or body subassembly 194 (with lower three dimensional and interior defining housing), these exhibiting mating and seating profiles and being sealingly engaged together in any desired fashion. In one non-limiting variant, this can include the upper and lower body portions being constructed of a durable plasticized material and being sonic (vibration) welded together following installation of the ball valve within the interior seat, along with the fluid communicating installation of the bristles within some or all of the selected apertures 188 associated with the flattened surface of the lower base subassembly.

The brush attachment 156 can define part of a kit including the collapsible and grate supported table 10 and it is further envisioned that the respective components may also be sold separately.

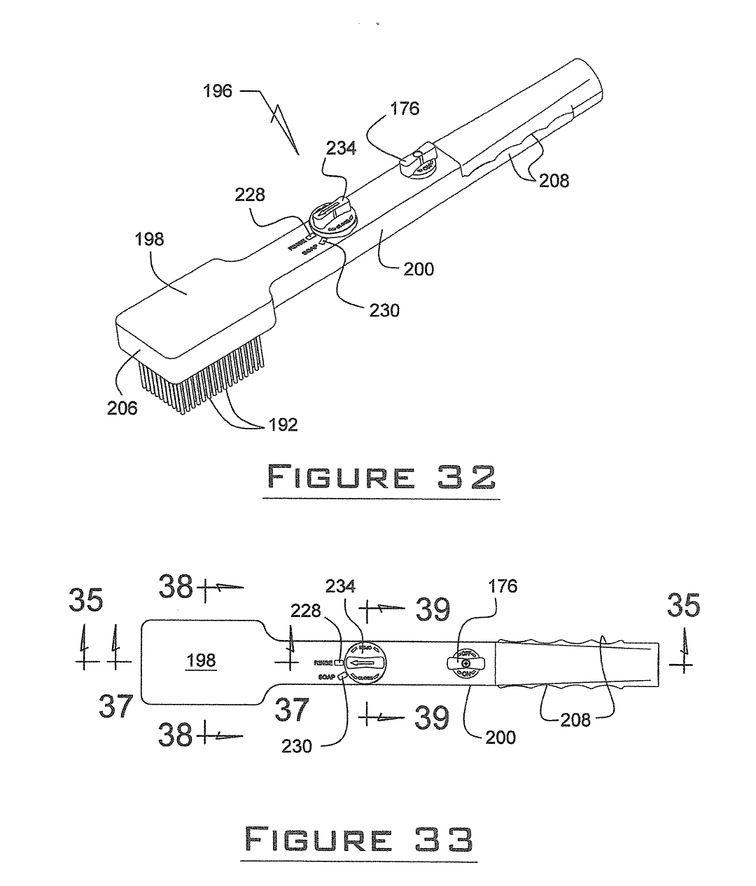

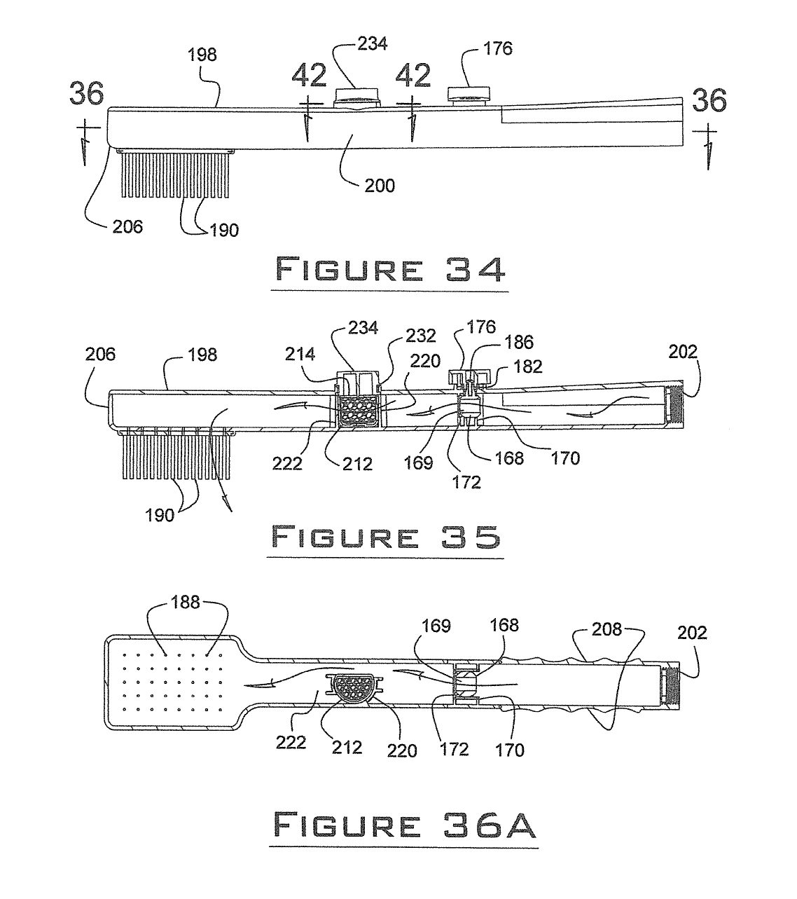

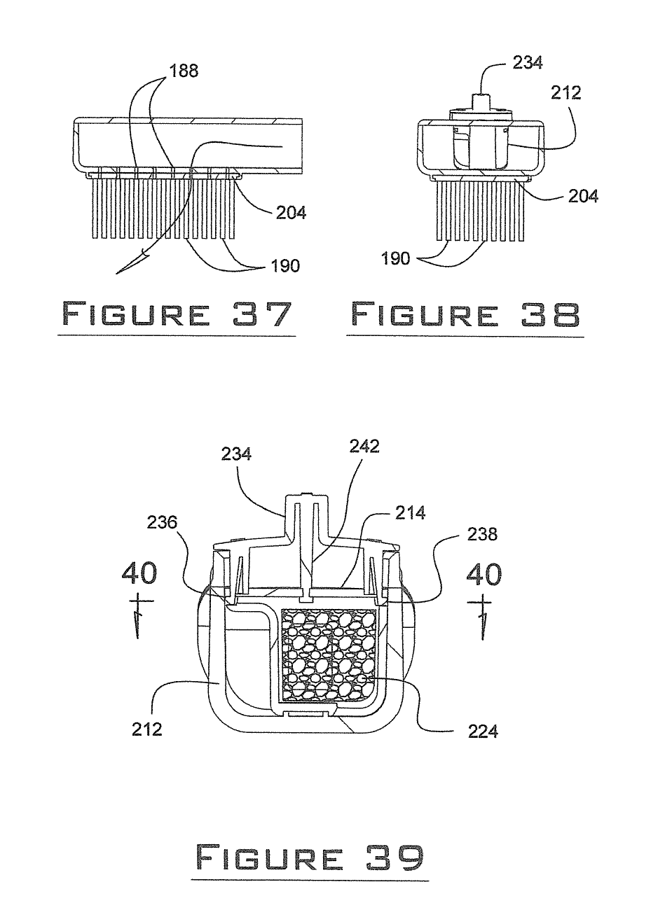

Referring now to FIG. 32, a perspective view is generally shown at 196 of a cleaning brush attachment according to a further variant compared to that depicted in FIG. 21. For purposes of ease of illustration, description of FIGS. 32-41 will be limited to newly added features associated with the identified variant, notably the incorporation of the soap dispensing sub-assembly, with identical features compared to the prior variant of FIG. 21 being noted without further explanation.

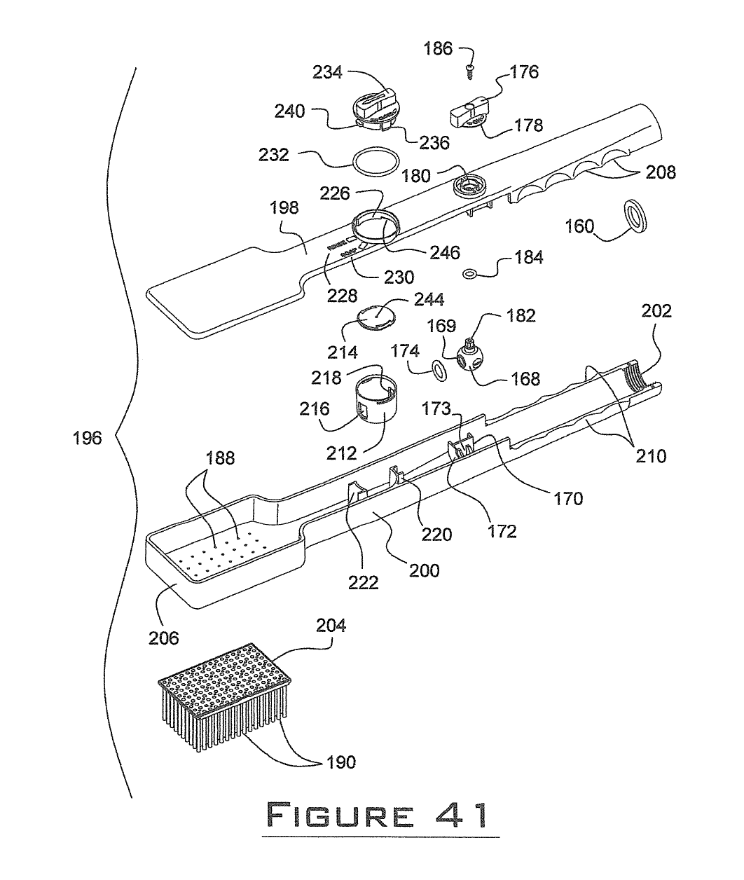

With initial reference again both to FIG. 32 along with the exploded perspective of FIG. 41, lengthwise assembleable upper 198 and lower 200 halves are depicted which are similar to that depicting the previous brush attachment 156 of FIGS. 21-31, this including the upper half 198 exhibiting a substantially flattened profile, with the lower half 200 being configured as a three dimensional and depth defining body which, upon assembly of the upper half 198. Upon assembly, the upper 198 and lower 200 halves collectively define a lengthwise flow communicating interior extending from a rear threaded engagement location 202, through the walls 170 and 172 defining the recessed seat for the rotary on/off valve 168, forward to the soap dispensing subassembly hereinafter described, forward to head attachment including the underside flow apertures (again at 188) and the underside mounting bristles (again at 190).\

As best shown in FIG. 41, an aperture support pad 204 is provided to which the bristles are secured and which can in turn facilitate mounting (such as by lengthwise tab/slot, fasteners or any other suitable manner) to the apertured underside (further at 206 in FIG. 41) of the brush attachment location defined in the assembleable base 200. In comparison to the brush housing in FIG. 21, it is further noted that the opposing handle gripping surfaces associated with the assembleable flat top 198 and depth defining bottom 200 each include contoured or scalloped gripping profiles (see opposing surfaces 208 and 210), and such as which provides additional gripping even when the attachment and user's hand is soapy and wet.

As previously described, the modified brush attachment 196 incorporates a soap dispensing feature which includes a removable container including a cylindrical shaped body 212 and a lid 214. The body is further defined by a pair of aligned windows 216 and 218 (see again as best shown in FIG. 41) formed in spaced apart wall locations. Upon being installed within a substantially semi-cylindrical seating location configured within the fluid communicating interior pathway of the base 200 (see pair of arcuate walls 220 and 222) so that the fluid communicating windows 216 and 218 are seated inside of the walls 220 and 222, a volume of liquid or powder soap (at 224 in FIG. 39) can be filled into the open top of the cylindrical body 212, following which the lid 214 is applied.

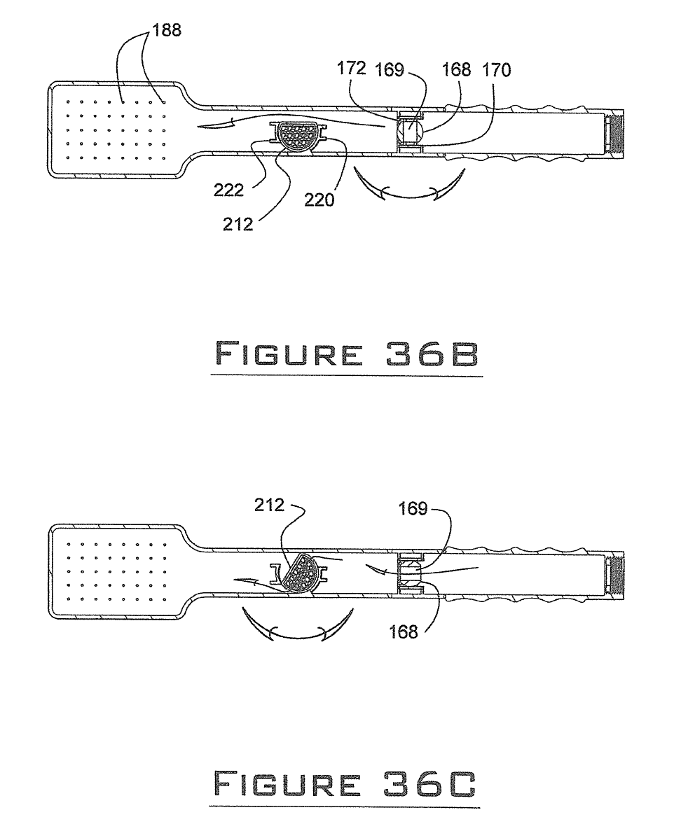

The soap dispensing feature is located forwardly of the rotary on/off ball valve 168 and base mounted seat (walls 170 and 172). As further illustrated in the overhead cutaways of FIG. 36A-36C, the soap dispensing body can incorporate either a generally cylindrical or pseudo-cylindrical shape as further shown and in order to be converted between a closed/rinse position (see FIG. 36A) and an open/soap dispensing position (FIG. 36C) in which fluid flow permitted through the ball valve 168 either bypasses the closed soap dispenser (again FIG. 36A) or is caused to flow through the soap filled interior (FIG. 36C) in order to administer a soapy solution through the bristle head apertures 188 and onto the exterior formed bristles 190.

As again is best shown in the exploded assembly of FIG. 41, an annular seating profile 226 is defined in the handle 198 and which, upon assembly with the depth defining base 200, facilitates rotary adjustment of the soap dispenser assembly between in-line/closed position or rinse position 228 and rotary adjusted open/soap dispensing position 230. Additional features include the provision of an o-ring seal 232 which is compressed between a top and snap-inserted knob 234 and an inner annular profile of the seat 226, this in order to fluidly seal the soap dispenser within the fluid communicating housing when the component combination is inserted into the brush housing and rotated to lock in place via two tabs (see at 236 and 238 in FIG. 39) projecting from the underside of the engagement cap 234 when assembled over the annular seat 226 defined into the upper brush housing 198.

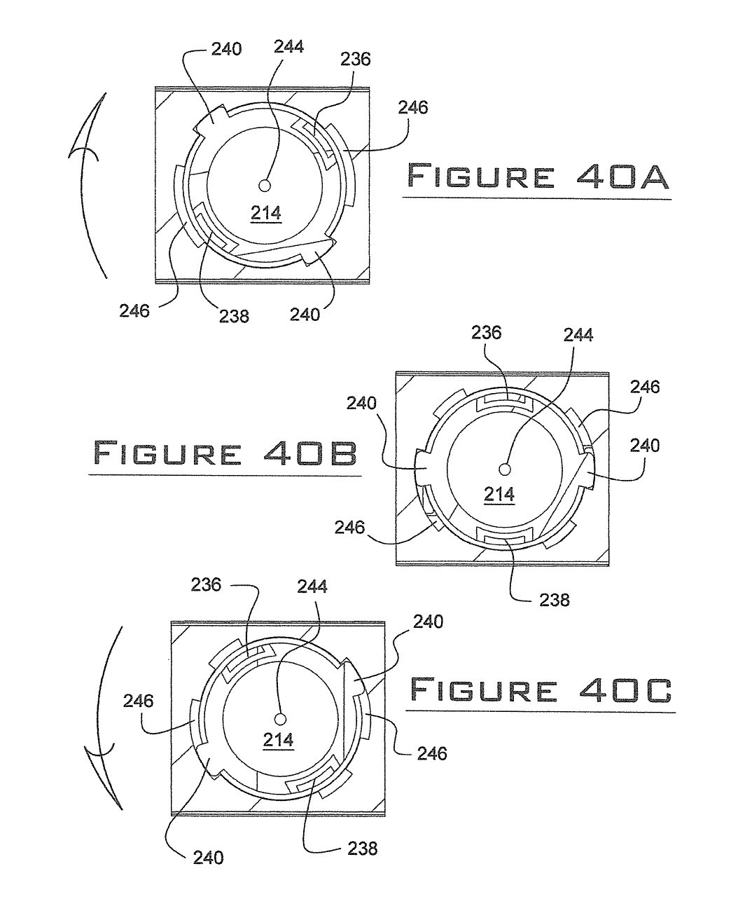

At this point, and as previously described, the cap 234 is capable of being rotated to either desired positions, soap 230 or rinse 228. As further depicted on the underside of the housing cover 198, and as best illustrated in FIG. 41 in combination with cutaway views FIGS. 40A-40C, a raised portion 240 in the tab rotation slot provides a stop so as to not over rotate from either position. To open and remove, the cap 234 is first depressed, compressing the o-ring 232 and allowing for further rotation to align the tabs with the two slots of the hole for removal (see also FIG. 40B).

Comparing the cutaway profile of FIG. 39 with the succeeding tab and slot positions identified in FIGS. 40A-40C and corresponding positions identified in FIGS. 36A-36C, the twist and adjust aspects of the soap dispenser are best understood and which enable a user to quickly adjust between a closed and rinse position to an open and soap dispensing position. Other features include the cap 234 having a central inner extending support pedestal 242 (see FIG. 39) which seats within a central aperture 244 of the lid 214.

The underside rotational track with end-stop or abutment configuration is better shown from the annular seat 226 depicted in exploded perspective in FIG. 41, see one of two spaced and aligning underside tracks at 246, as well as is shown in cutaway plan view in each of FIGS. 40A-40C. In this fashion, the laterally extending wings or raised portions 240 in the installed cap are able to rotate within these tracks 246 between the rinse, soap, and install/remove positions previously described.

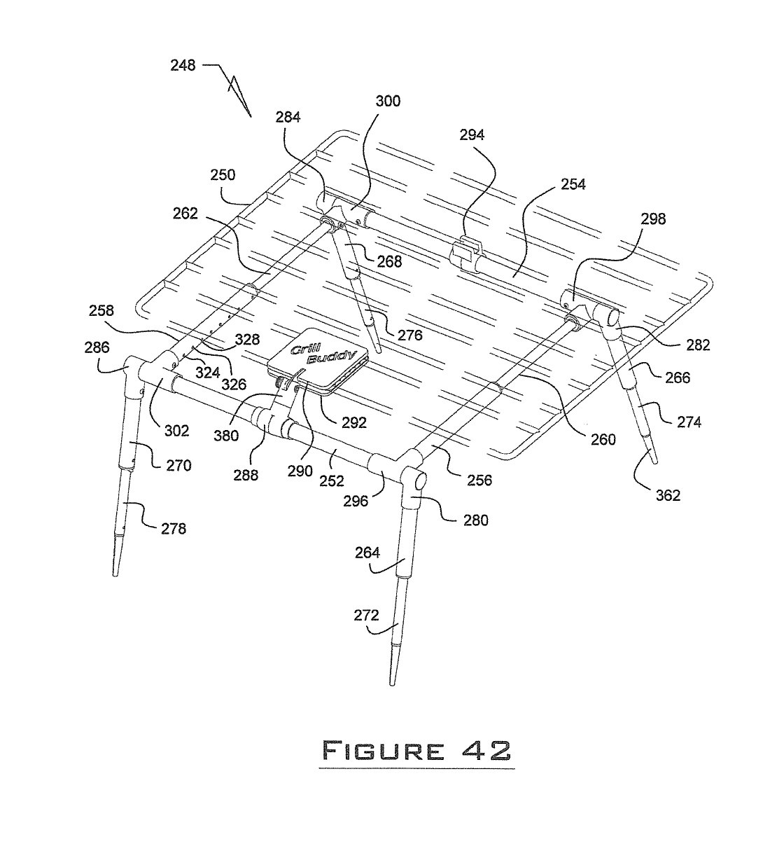

Proceeding now to FIG. 42, a partially exploded view is generally shown of a collapsible grate cleaning table 248 for supporting a grill grate, further depicted at 250, according to a further embodiment. As described throughout the succeeding figures, the collapsible grate cleaning table exhibits a four sided frame with a first pair of spaced apart sides (see conduit or tubular sections 252 and 254) interconnected by a second pair of telescoping sides (see as further identified by outer telescoping portions 256/258 and inner coaxially received telescoping portions 260/262).

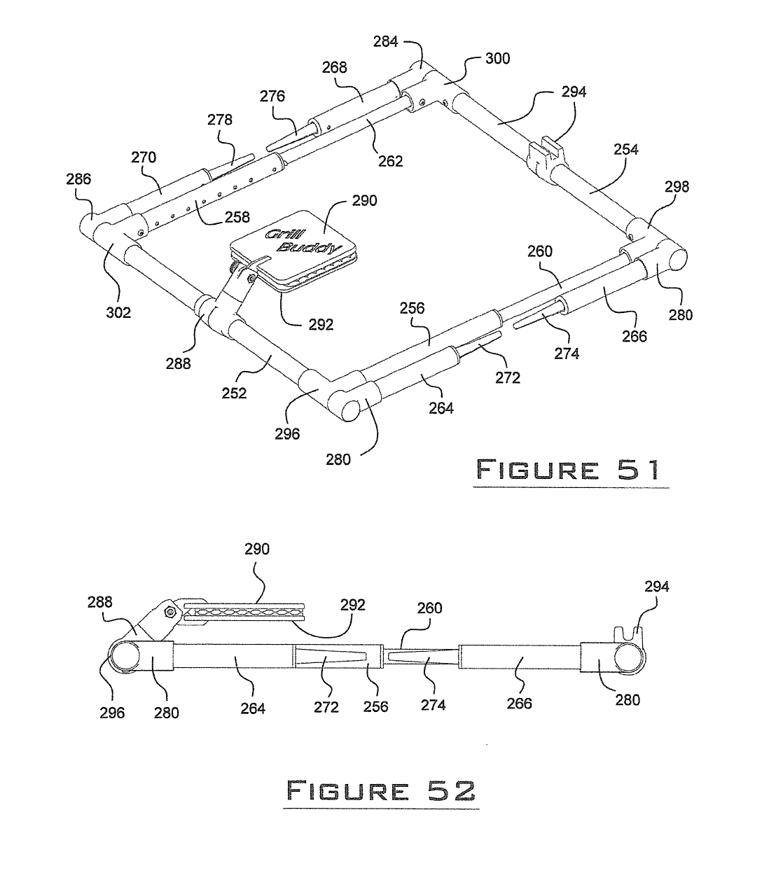

As with the preceding disclosed embodiment, the table can be constructed of any suitable material not limited to a lightweight metal or durable plastic. In the non-limiting embodiment illustrated, a plurality of four legs are further referenced and which are pivotally and respositionably secured to the respective corner locations of the frame as well as telescopically collapsible with converted to a non-use/storage position (FIG. 51). The legs each include upper/outer telescoping portions 264, 266, 268 and 270 and respective lower/inner telescoping and ground support portions 272, 274, 276 and 278. As will be further described, uppermost collar shaped attachments 280, 282, 284 and 286 are provided, which are typically integrally formed or otherwise attached to the outer telescoping portions 264, 266, 268 and 270, respectively.

A fixture 288 is provided which is attached to a first selected 252 of the first pair of the sides, the fixture supporting a pair of pivotally displaceable clamps 290 and 292, each exhibiting a planar shape with an inwardly opposing surface for gripping and supporting therebetween the grate 250 between any of horizontal, vertical or other angularly disposed position. A clip 294 exhibiting a pair of upper facing gripping locations is secured to the other selected 254 of the first pair of frame defining members and is configured for gripping a selected extending grate portion upon the grate being secured between the clamps 290/292 and rotated to the horizontal position. The non-limited variant depicted also includes a plurality of four corner elbow attachments, see as best shown at 296, 298, 300 and 302 in each of FIGS. 42, 43 and 49 and which mount the first 252/254 and second telescoping 256/260 & 258/262 pairs of frame defining members together.

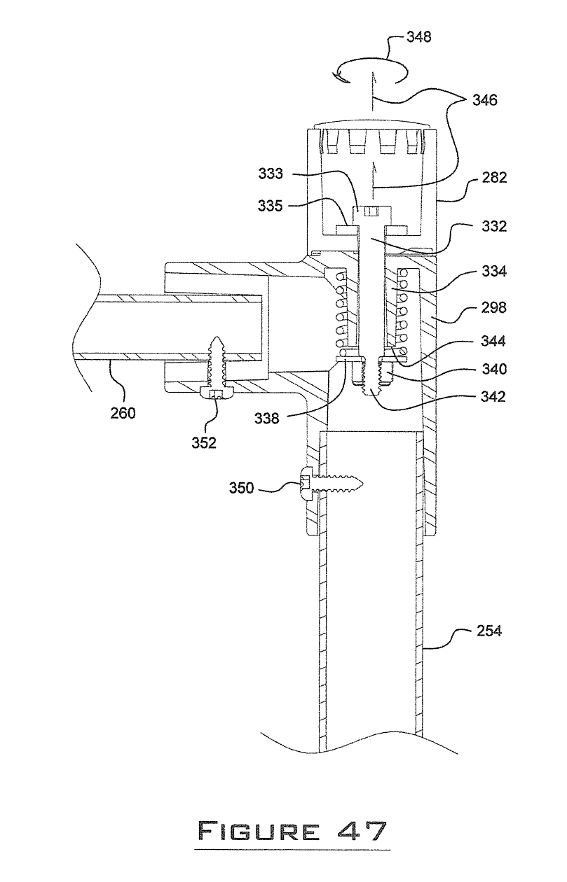

Having provided a general overview of the collapsible cleaning table construction, particular reference will now be made to various additional features associated with the illustrations. Referring to FIG. 46A, a cutaway taken along line 46-46 of FIG. 44 is shown and illustrates a selected telescoping side sub-assembly (illustrating outer telescoping portion 256 and inner coaxial portion 260) in an extended position. Illustrated in displaceable fashion within the outer tubular portion 256 is an interior collar having a base 304 and a pair of projecting walls 306 & 308, the walls supporting a hairpin shaped spring 310.

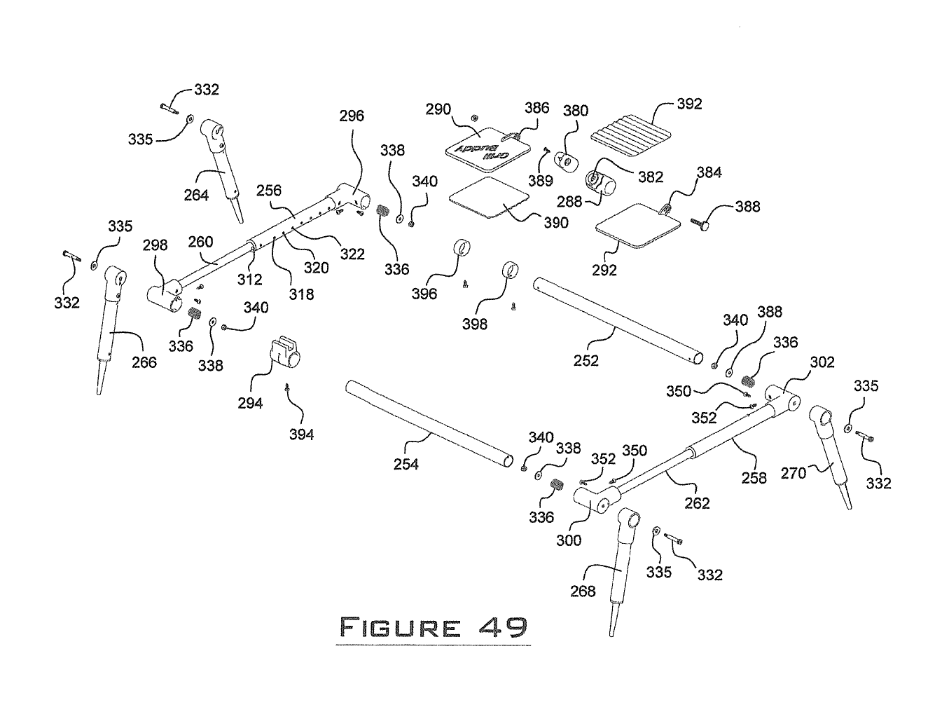

In the extended position, an outwardly angled detent 312 is secured to an extending end of the hairpin shaped spring 310 and projects through a first selected and aligning aperture configured within the wall of the inner telescoping portion 260, the detent 312 abutting an outer annular rim edge 313 of the outer telescoping portion 256. An angled shoulder edge 314 associated with the hairpin supporting wall 208 is further configured to engage an opposing angled edge of an inwardly facing tab 316 and, upon inwardly depressing the detent 312 within the open interior of the inner telescoping portion 260, the inner portion 260 is permitted to displace within the hollow interior of the outer telescoping portion 256 until aligning with a selected spaced apart aperture (see at 318, 320, 322 et seq. in FIG. 49) at which point the detent 312 exteriorly reseats through the selected aperture to establish a selected reduced (also termed collapsed) overall distance (FIG. 46B) achieved by concurrent telescoping adjustment of both the frame defining and telescoping sub-assemblies 256/260 and 258/262). To this end, an identical construction for the second telescoping subassembly (outer 258 and inner 262 portions) is provided and can include a further corresponding plurality of length adjustable apertures 324, 326, 328 et seq. (FIG. 42) associated with the outer portion 258.

Proceeding to FIG. 47, a cutaway view taken along line 47-47 of FIG. 44 illustrates a selected interconnecting corner 298 of the table and including the mechanism for permitting the rotational adjustment of the associated leg (upper/outer 264 and lower/inner 274 telescoping portions which are hidden from view). Each of the legs are configured so as to be rotationally adjustable in multiple positions relative to the corner supporting locations of the upper rectangular frame. This includes the uppermost leg connecting portions 280, 282, 284 and 286 each being spring loaded into biasing contact with outer opposing surfaces associated with each of the elbow shaped corners 296, 298, 300 and 302.

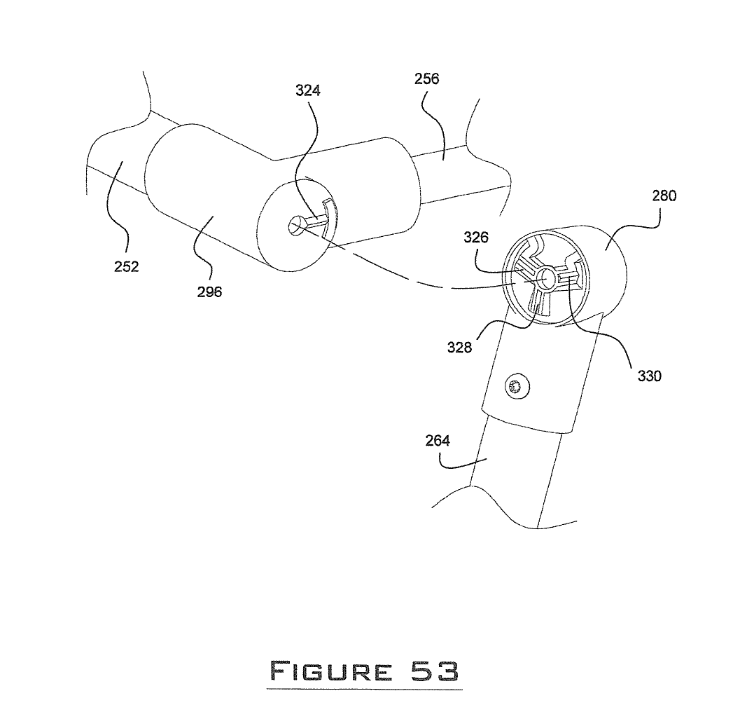

As best depicted in the partial and corner exploded view of FIG. 53, a surface configured protrusion 324 associated with selected corner 296 is configured to seat a mating profile 326, 328 or 330 defined in circumferentially offset fashion upon an inner facing surface of the leg upper end connecting portion 280 (this enabling multi position adjustment of each leg from the use position in FIG. 42 to the stored position of FIG. 51.

Referring back to FIG. 47, further selected corner 298 (each of the four being identical in construction) further exhibits a bolt 332 having an enlarged head 333 seated against an inner base surface of the leg connecting portion 282, via a first washer 335 seated upon an interior face of a base surface of the leg connecting portion 282. The shaft of the bolt 332 projects from an aperture in the base surface of the connection portion 282 and through and beyond an interior and integrally formed collar 334 configured within the aligning and communicating interior of the elbow shaped corner 298.

A coil spring 336 surrounds the interior collar 334, a bottom most end thereof biasing against a further washer 338 in turn supported by a nut 340 attached to end disposed threads 342 of the bolt 332. A separation distance between the washer 338 and an annular end face 344 of the interior collar 334 is closed by grasping and linearly outwardly displacing the corner portion 282 of the leg (see arrows 346 in FIG. 47, following which the associated leg is rotated (further arrow 348) to a position in which opposing profiles (again referencing as shown at 324 for corner elbow 296 and at 326/328/330 for leg upper connecting portion 280 in FIG. 53) realign, at which point the corner portion 280 is released with the spring 336 biasing the corner 280 into a rotationally adjusted engagement position. Also shown in FIG. 47 are screws 350 and 352 for engaging the extending tubular shaped portions 254 and 260 of the succeeding interconnecting sides.

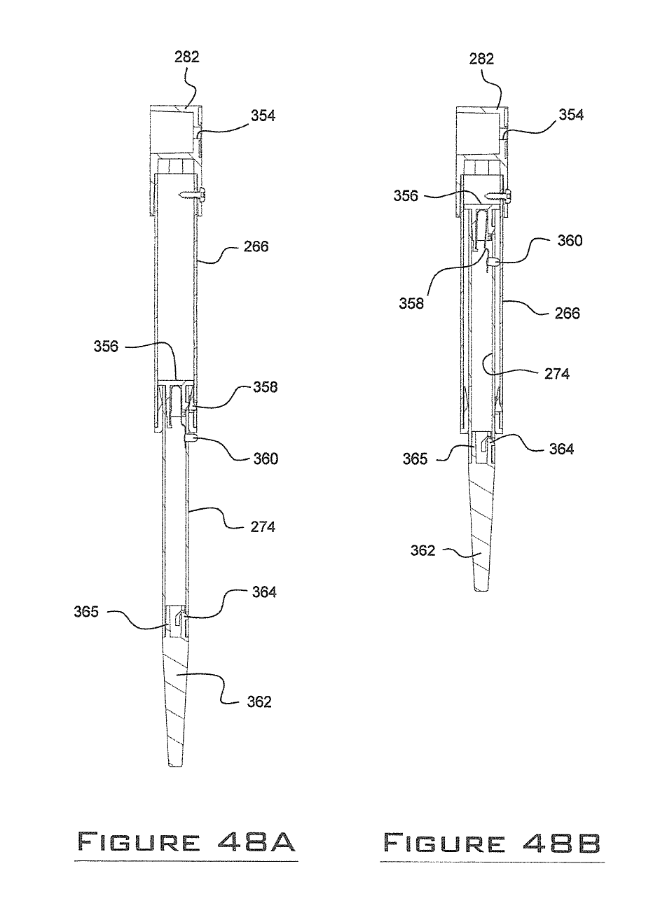

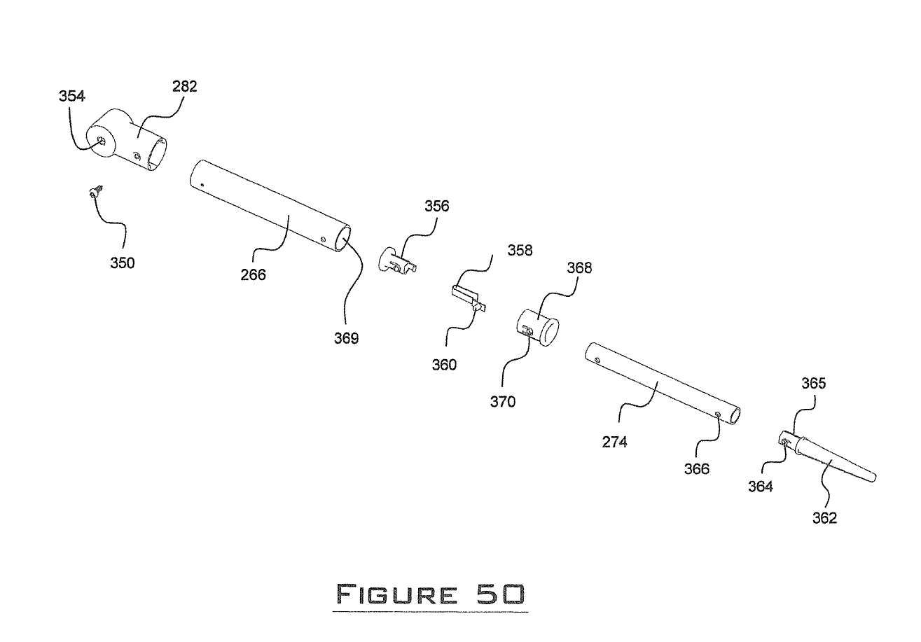

FIG. 48A is a cutaway view taken along line 48-48 of FIG. 44 and illustrates a selected leg in a telescoping position. In combination with the exploded view of FIG. 50, an aperture (see inner perimeter wall 354) is defined in the inner base surface of the connection portion 282 (this corresponding to the location where the first washer 335 in FIG. 47 seats). An inwardly displaceable support collar 356 with supported hairpin spring 358 and detent 360 is provided similar to that associated with the telescoping frame members (FIGS. 46A-46B) and for collapsing the legs in the manner shown in FIG. 48B.

The lower/inner telescoping portion 274 is engaged by a bottom most elongated pedestal 362, such further including an end situated detent spring loaded portion 364 for seating a narrowed collar 365 of the pedestal into a hollow end of the inner portion 274. An end collar 368 engages over an annular end surface 369 of the outer telescoping portion 266 (again FIG. 50) and includes a side wall disposed aperture for seating the hairpin spring detent 360 in the expanded position of FIG. 48A. Upon inwardly displacing the hairpin detent 360, the lower telescoping leg portion 274 is readjusted in a collapsing direction toward and into the upper portion 266 in the manner further depicted in FIG. 48B, such as a preliminary to rotating the legs to the parallel and collapsed position relative to the frame in FIG. 51.

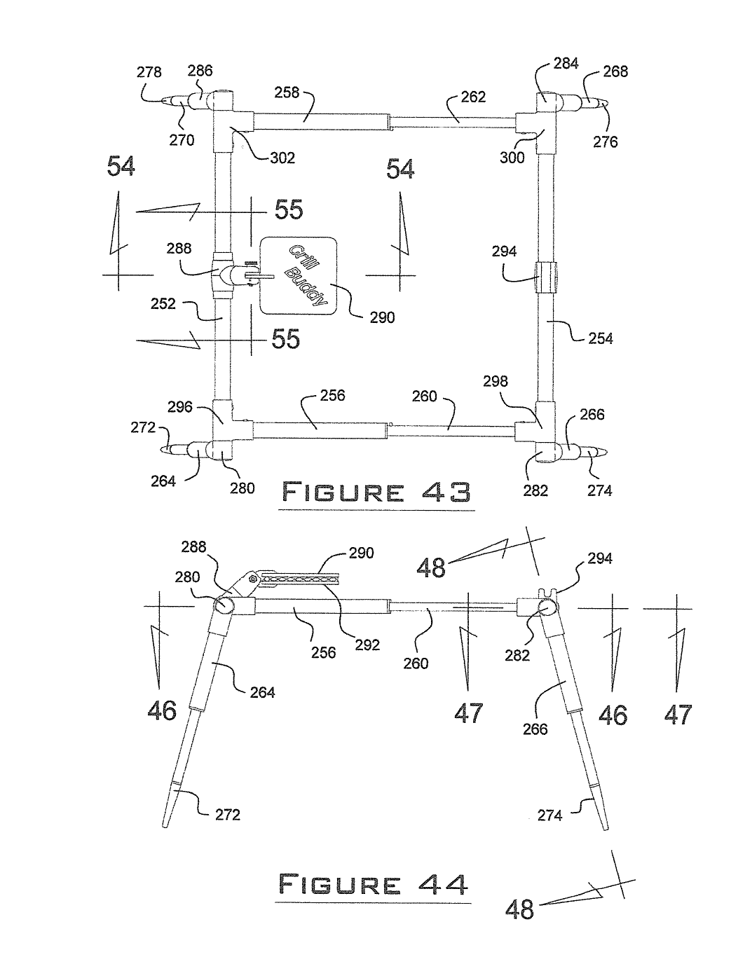

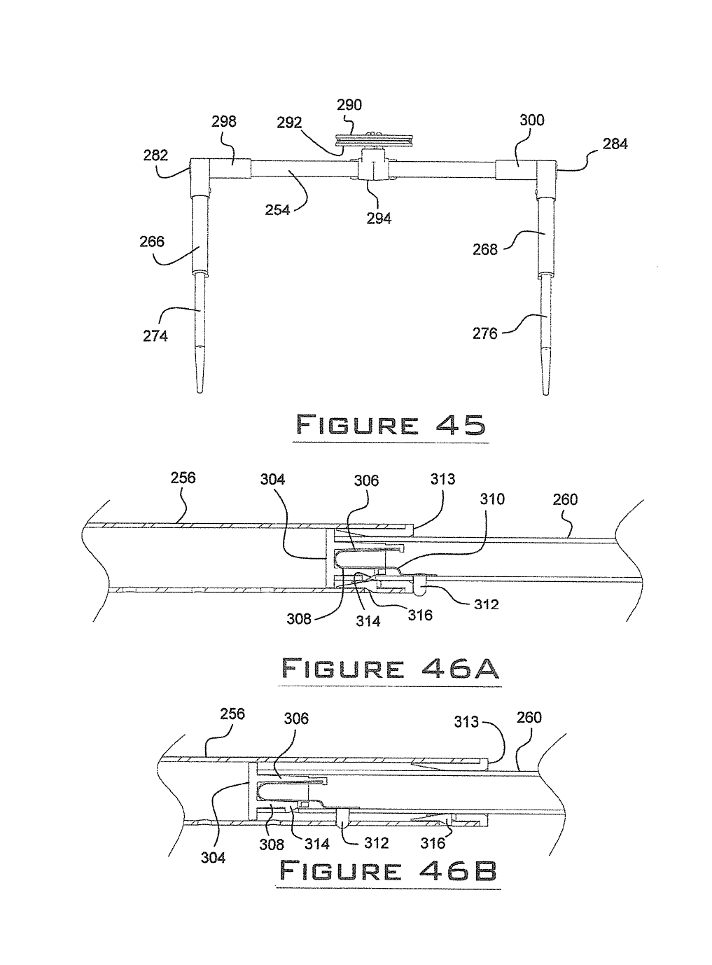

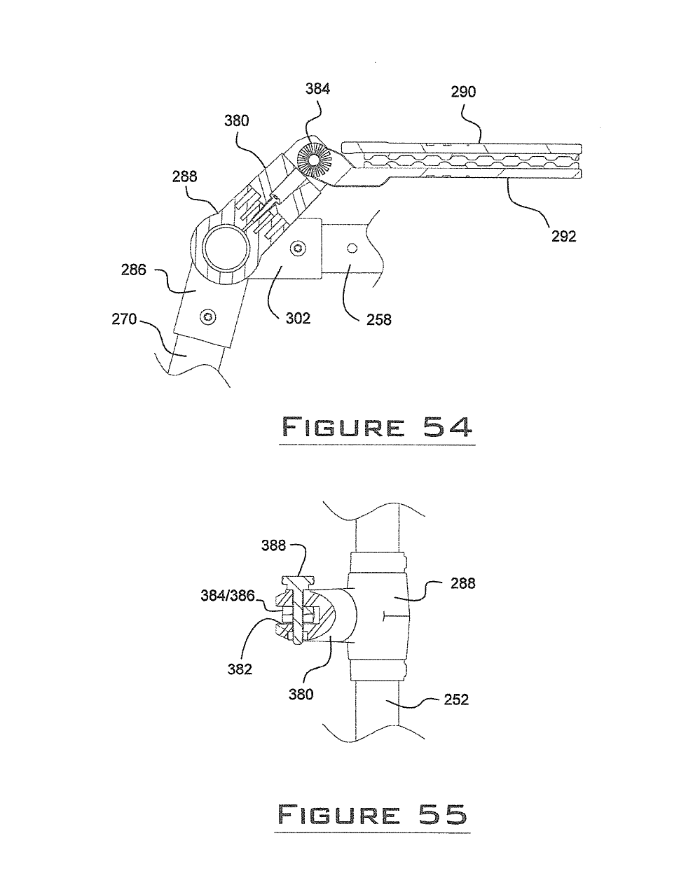

FIG. 54 is a cutaway taken along line 54-54 of FIG. 43 and further illustrating the grate table clamp and supporting fixture. In combination with the exploded view of FIG. 49, additional features include a neck 380 secured to an upper end of the fixture 288. Opposing surfaces associated with the neck and fixture are exhibited by circumferential patterns of mating portions, see at 382 in FIG. 54, and which are defined in overlapping plural fashion between an extending end of the fixture 288 (at 382) and an inner supporting surface 384 of a selected clamp 292.

A tightening screw 388 engages through the mating/opposing and rotationally adjusting patterns and enables the assembled clamps 290/292 to be angularly repositioned relative to the fixture 288. A further screw 389 secures a supporting end surface 386 of the upper clamp 290 to neck 380 and in order to pivot the upper clamp relative to the (lower clamp 292).

Also depicted are gripping pads 390 and 392 which can be adhered or glued to inner facing support surfaces of the clamps 290 and 292 and which collectively define a gripping surface for engaging the grate 250. Finally, FIG. 55 is a cutaway view taken along line 55-55 of FIG. 43 and illustrating the pivot support fastener 388 associated with the grate clamp support fixture and engaging portions 384/386 of the clamps 290/292.

Referencing exploded FIG. 49, additional noted features include a fastener 394 for mounting the grate clip 294 to the tubular portion 254 of the frame portion 254. Additional collar supports 396 and 398 are provided for supporting the clamp fixture 288 and extending neck 380 to the further selected frame defining portion 252.

As previously described, the collapsible and grill grate supporting table and cleaning brush can be provided in a kit or assembly form. Having described my invention, other and additional preferred embodiments will become apparent to those skilled in the art to which it pertains and without deviating from the scope of the appended claims.

I claim:

1. A collapsible table for supporting a grate like structure, comprising:
a four sided perimeter extending frame including a first pair of parallel spaced apart and extending portions which are interconnected at respective ends by a second pair of telescoping portions;
a plurality of legs extending downwardly from corner locations of said frame; and
a clamp secured to a location of said frame and which is adapted to engage and support the grate like structure in position over said table to permit cleaning of the same.

2. The invention as described in claim 1, said legs each further an uppermost portion rotationally supported relative to said connecting corner locations of said frame.

3. The invention as described in claim 2, further comprising a bolt having an enlarged head seated against an inner base surface of said leg connecting portion, a shaft of said bolt projecting from an aperture in said base surface of said connection portion and through and beyond an interior and integrally formed collar configured within an aligning and communicating interior of said corner location, a coil spring surrounding said interior collar, with a bottom most end thereof biasing against a further washer in turn supported by a nut attached to end disposed threads of said bolt, a separation distance between said washer and an annular end face of said interior collar being closed by grasping and linearly outwardly displacing said corner portion of said leg.

4. The invention as described in claim 2, further comprising a surface configured protrusion associated with said corner locations being configured to seat one of a plurality of circumferentially offset mating profiles defined upon an inner facing surface of said upper leg connecting portion to enable multi position adjustment of each leg.

5. The invention as described in claim 1, each of said legs further comprising first and second telescoping portions.

6. The invention as described in claim 5, said telescoping portions of said legs, as well as said second pair of telescoping portions associated with said four sided frame, each further comprising a collar displaceably supported within an outer selected telescoping portion, a hairpin spring with outward supported detent being seated within said collar such that said detent may be inwardly depressed unseat from engagement with an inner selected telescoping portion and to adjust an overall length established between said telescoping portions, at which said detent outwardly reseats through an aperture defined in said inner of said telescoping portions to affix said portions at said telescopically adjusted position.

7. The invention as defined in claim 1, said clamp further comprising a supporting fixture from which extend a pair of planar shaped clamping portions in pivotally adjustable fashion.

8. The invention as described in claim 7, further comprising a neck secured to an upper end of said fixture, opposing engaging surfaces associated with said neck and at least one of said clamps exhibited by overlapping mating portions, a tightening screw engaging through said mating portions.

9. The invention as described in claim 8, further comprising an additional screw securing a supporting end surface of an upper selected one of said clamps to pivot said upper clamp relative to a lower selected one of said clamps.

10. The invention as described in claim 9, further comprising gripping adhered to inner facing support surfaces of said clamps.

11. The invention as described in claim 1, further comprising a clip secured to a further location of said frame and adapted to engage a further extending location of the grate like structure in a horizontally extending position.

12. A collapsible table for supporting a grate like structure, comprising:
a central and vertically extending column;
a plurality of perimeter spaced outer columns which are interconnected to said central column by articulating frame portions;
an upper extending location associated with at least said outer columns defining a support for restraining and seating a location associated with the grate; and
at least one actuating portion mounted to said central column and including additional displacing stems engaging intermediate locations associated with each of said articulating frame portions in order to convert said table between an outwardly extended support position and an inwardly retracted non-use position.

13. The invention as described in claim 12, further comprising upper and lower tiers of articulating frame portions.

14. The invention as described in claim 13, further comprising upper and lower tiers of vertically displaceable collars mounted to each of said central column and said perimeter spaced columns and between which are mounted said articulating frame portions.

15. The invention as described in claim 14, said actuating portions further comprising upper and lower vertically displaceable drum portions supporting said hingedly extending stems connecting to articulating locations associated with each of said upper and lower tier frame portions, said drums being actuated by a release trigger to slide in oppositely and linearly outwardly movable fashion along said central column to outwardly collapse said articulating frame portions.

16. The invention as described in claim 12, further comprising a selected upper end location of an outer column further comprising a gripping structure including first and second clamping members for biasingly engaging a corner location of the grate.

17. The invention as described in claim 16, said grate gripping structure further exhibiting a hinged connection to said associated column for permitting said clamping members to pivot the grate from a first horizontally supported position to a further upwardly angled position.

18. The invention as described in claim 12, said upper extending support locations further comprising top mounted crown portions with interior seating locations for supporting and restraining corner locations of the grate.

19. The invention as described in claim 12, further comprising cushioned pedestal supports mounted to bottom ends of said central and outer perimeter columns.

20. A kit assembly including each of a collapsible table for supporting a grate like structure and a fluid communicating cleaning brush, said kit assembly comprising:
a four sided perimeter extending frame including a first pair of parallel spaced apart and extending portions which are interconnected at respective ends by a second pair of telescoping portions;
a plurality of legs extending downwardly from corner locations of said frame;
a clamp secured to a location of said frame and which is adapted to engage and support the grate like structure in position over said table to permit cleaning of the same;
said cleaning brush having a linear elongated and internally hollowed body including a first fluid coupling attachable end and a second fluid flow distributing end coinciding with placement of a plurality of bristle portions;
an intermediate positioned valve located within a fluid communicating interior of said body and actuating between a first position to permit fluid flow through to said bristle portions and a second position interrupting fluid flow; and
a female threaded interior defined at a rear end of said body and which is engaged by a male threaded exterior associated with a garden hose.

21. The kit as described in claim 20, said valve further comprising a ball valve seated within an interior seat defined within said body and which is actuated by a rotating knob supported atop said body and which engages an upwardly extending post associated with said valve.

22. The kit as described in claim 20, said second flow distributing end further comprising a plurality of apertures defined within a flattened end profile in cooperation with mounting of said bristle portions.

23. The kit as described in claim 20, said elongated and interiorly hollowed body further comprising a flattened top and a three dimensional interior defining body, said top and body exhibiting mating and seating profiles and each further exhibiting a plasticized construction which is assembled in a vibration or sonic welding operation.

24. The kit as described in claim 23, further comprising a soap dispenser sub-assembly located forwardly of said valve and which is rotated between a first closed and rinse position and a second open and soap dispensing position.

25. The kit as described in claim 24 further comprising an arcuate seat formed in a fluid communicating location of said elongated body for seating either of a cylindrical or pseudo-cylindrical shaped dispensing body.

26. The kit as described in claim 24, further comprising an annular seat defined in said flattened top and communicating a twist cap with said sealed soap dispenser between said rinse and soap dispensing positions.

27. The kit as described in claim 26, further comprising an O-ring seat positioned between said twist cap and said annular seat.

28. The kit as described in claim 26, further comprising a tab and slot configuration established between said cap and annular seat for facilitating rotation of said soap dispensing body between rinse, soap dispensing and subassembly removal positions.
